(19) United States
(12) Patent Application Publication
(10) Pub. No.: US 2006/0140273 A1
(43) Pub. Date: Jun. 29, 2006

(54) Dual-pass HDTV encoder with noise reduction

(76) Inventor: Siu-Wai Wu, San Diego, CA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/023,686

(22) Filed: Dec. 28, 2004

(51) Int. Cl. H04N 11/02; H04N 7/12; H04B 1/66; H04N 11/04

(52) U.S. Cl. 375/240.16

(57) ABSTRACT

An exemplary embodiment of an apparatus (10) for encoding a high definition television signal includes an image decimator and cropper (11) to convert the high definition television signal to a lower resolution television signal and two encoders (12, 16). The first video encoder (12) is coupled to the image decimator and cropper (11) and generates motion vectors and statistics for look ahead rate control and statistical multiplexing related to the converted high definition television signal. The second video encoder (15) receives the generated statistics, receives the filtered high definition video signal and to encodes the high definition video signal using the generated statistics. A buffer (14) receives the filtered high definition television signal and stores the filtered high definition television signal for subsequent use. Another buffer (16) is coupled to the first encoder (12) to receive the generated statistics and to store the generated statistics for subsequent use. A filter (13) is coupled to the first encoder (12) and receives the high definition television signal, receives the generated motion vectors and performs motion compensated temporal filtering of the received high definition television signal using the received generated motion vectors. An exemplary embodiment of a method (20) for encoding a high definition video signal first converts (21) the high definition video signal to a lower resolution video signal prior to encoding. Next, motion vectors are generated (22) from the lower resolution video signal. The high definition video signal is filtered (23) with a motion compensated temporal filter using the generated motion vectors. Also, statistics for look ahead rate control and statistical multiplexing regarding the lower resolution video signal are generated (25) by a first encoder and used when encoding (27) the filtered high definition video signal.

### FIELD OF THE INVENTION

The present invention relates generally to methods and apparatuses for encoding video signals, and more particularly to a method and apparatus for encoding high-definition television signals.

### BACKGROUND

To increase the quality of high definition video encoders has proven expensive. Thus, the present invention is therefore directed to the problem of developing a method and apparatus for encoding a high-definition television signal that performs encoding of a high definition video signal in an in expensive manner but without loss of quality.

### SUMMARY OF THE INVENTION

The present invention solves these and other problems by providing a method and apparatus for encoding a high definition video signal that employs a dual pass encoding process but only requires one high definition encoder.

According to one aspect of the present invention, an exemplary embodiment of a method for encoding a high definition video signal first converts the high definition video signal to a lower resolution video signal prior to encoding. Next, motion vectors are generated from the lower resolution video signal. The high definition video signal is filtered with a motion compensated temporal filter using the generated motion vectors. Also, statistics for look ahead rate control and statistical multiplexing regarding the lower resolution video signal are generated by a first pass encoder and used when encoding the filtered high definition video signal.

According to another aspect of the present invention, an exemplary embodiment of an apparatus for encoding a high definition television signal includes an image decimator and cropper to convert the high definition television signal to a lower resolution television signal and two encoders. The first video encoder is coupled to the image decimator and cropper and generates motion vectors and statistics for look ahead rate control and statistical multiplexing related to the converted high definition television signal. The second video encoder receives the generated statistics, receives the filtered high definition video signal and to encodes the high definition video signal using the generated statistics. A buffer receives the filtered high definition television signal and stores the filtered high definition television signal for subsequent use. Another buffer is coupled to the first encoder to receive the generated statistics and to store the generated statistics for subsequent use. A filter is coupled to the first encoder and receives the high definition television signal, receives the generated motion vectors and performs motion compensated temporal filtering of the received high definition television signal using the received generated motion vectors.

According to still another aspect of the present invention, an apparatus for encoding a high definition television signal uses a dual pass encoding technique. A first processor converts the high definition television signal to a standard television signal. A second processor (or video encoder) generates statistics for look ahead rate control and statistical multiplexing related to the converted high definition television signal. A video encoder receives the generated statistics, the high definition video signal and encodes the high definition video signal using the generated statistics. The second processor generates motion vectors from the standard television signal. A filter coupled to the second processor receives the high definition television signal, the generated motion vectors and performs motion compensated temporal filtering of the received high definition television signal using the received generated motion vectors. The video encoder uses the filtered version of the high definition video signal for encoding. The video encoder includes multiple standard video encoders coupled in parallel each performing encoding of portions of the high definition signal.

### BRIEF DESCRIPTION OF THE DRAWINGS

FIG. 1 depicts an exemplary embodiment of a Dual Pass High Definition Video Signal Encoder according to one aspect of the present invention.

FIG. 2 depicts an exemplary embodiment of a method for performing encoding of a high definition video signal according to another aspect of the present invention.

FIG. 3 depicts another exemplary embodiment of a dual pass encoder according to another aspect of the present invention

### DETAILED DESCRIPTION

It is worthy to note that any reference herein to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

U.S. Patent Application Publication No. US 2003/0039310 A1 by one of the same inventors discloses a method and apparatus for reducing noise by performing preprocessing of a digital video signal using previously generated motion vectors and adaptive spatial filtering. The present invention makes use of this method and apparatus in a dual pass high-definition video signal encoder. U.S. Patent Application Publication No. US 2003/0039310 A1 is therefore incorporated by reference herein as if repeated in its entirety, including the drawings.

U.S. Patent Application Publication No. US 2003/0235247 A1 by one of the same inventors discloses a method and apparatus for rate control during dual pass encoding of a digital video signal. The present invention makes use of this method and apparatus in a dual pass high-definition video signal encoder. U.S. Patent Application Publication No. US 2003/0235247 A1 is therefore incorporated by reference herein as if repeated in its entirety, including the drawings.

U.S. Pat. No. 6,804,301 by one of the same inventors discloses a method and apparatus for first pass encoding of I and P-frame complexity for compressed digital video. The present invention makes use of this method and apparatus in a dual pass high-definition video signal encoder. U.S. Pat. No. 6,804,301 is therefore incorporated by reference herein as if repeated in its entirety, including the drawings.

U.S. Patent Application Publication No. US 2003/0235220 A1 by one of the same inventors discloses a method and apparatus for statistical multiplexing during dual pass encoding. The present invention makes use of this method and apparatus in a dual pass high-definition video signal encoder. U.S. Patent Application Publication No. US 2003/0235220 A1 is therefore incorporated by reference herein as if repeated in its entirety, including the drawings.

International PCT Patent Application No. PCT/US99/22663, entitled “Method And Apparatus For Providing Rate Control In A Video Encoder” and filed on 29^{th} Sep. 1999 by one of the same inventors discloses a method and apparatus for providing rate control in video encoding. The present invention makes use of this method and apparatus in a dual pass high-definition video signal encoder. InternationL PCT Patent Application No. PCT/US99/22663 is therefore incorporated by reference herein as if repeated in its entirety, including the drawings.

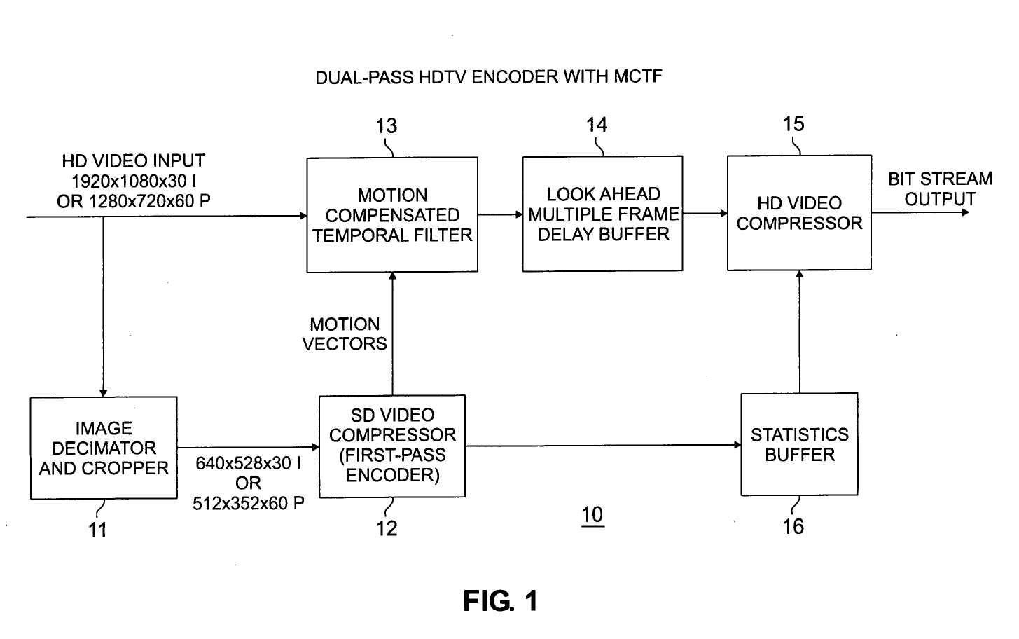

Turning to FIG. 1, shown therein is an exemplary embodiment 10 of an apparatus for performing dual encoding of a high-definition television signal. The embodiment 10 includes an Image Decimator and Cropper 11, a first pass encoder 12 (e.g., a standard definition video compressor), a motion compensated temporal filter 13, a buffer 14, a second pass encoder 15 (e.g., a High Definition Video Compressor), and a statistics buffer 16.

According to one aspect of the present invention, input high definition television (HDTV) video is decimated and cropped to generate a lower resolution image that can be processed by a standard definition video compressor. The Image Decimator and Cropper 11 performs this decimation and cropping. An example of a device that performs this image decimation and cropping includes a standard video processor, such as a Field Programmable Gate Array device manufactured by Altera Inc or Xilinx Inc.

For example, for a 1080I input, each frame is vertically decimated from 1080 lines to 540 lines (i.e., a two-to-one decimation), and each scan line is re-sampled from 1920 pixels to 640 pixels (i.e., a three-to-one re-sampling). Then six lines are cropped from the top and six lines are cropped from the bottom of each picture to form a 640×528 image so that there are exactly 40×33 macroblocks in every frame (30 or 29.97 frames per second interlaced).

For example, for a 720P input, each frame is vertically decimated from 720 to 360 lines (2:1 decimation), and each scan line is re-sampled from 1280 pixels to 512 pixels (5:2 re-sampling). Then four lines are cropped from the top and four lines are cropped from the bottom so that each frame has exactly 32×22 macroblocks in every frame (60 or 59.94 frames per second interlaced).

The first-pass encoder 12 compresses the resized and cropped image with a fixed quantizer scale to generate statistics for lookahead rate control and statistical multiplexing, as set forth in U.S. Patent Application Publication No. US 2003/0235247-A1 “Methods and Apparatus for Rate Control During Dual Pass Encoding”, US 2003/0235220-A1 “Methods and Apparatus for Statistical Multiplexing During Dual Pass Encoding”, and U.S. Pat. No. 6,804,301 “First Pass Encoding of I and P Frame Complexity For Compressed Digital Video”, all of which have been previously incorporated by reference as if repeated herein in their entirety, including the drawings. The statistics generated by the first pass encoder 12 are stored in statistics buffer 16, for use by the second pass encoder 15. An example of a processor used for the first pass encoder includes DxVpert II processor.

The first-pass encoder 12 also detects scene change and determine the telecine mode and applies the information to the second-pass encoding, as set forth in U.S. Pat. No. 6,804,301 “First Pass Encoding of I and P Frame Complexity for Compressed Digital Video”, which has been previously incorporated by reference as if repeated herein in its entirety, including the drawings.

As a by-product, the first pass encoder 12 also generates motion vectors for every 16×16 blocks of the resized image. The motion vectors are applied to the motion compensated recursive temporal filter 13 as set forth in U.S. Patent Application Publication No.: US 2003/0039310-A1 “Noise Reduction Pre-Processor For Digital Video Using Previously Generated Motion Vectors And Adaptive Spatial Filtering”, which has been previously incorporated by reference as if repeated herein in its entirety, including the drawings. An example of a MCTF includes a digital signal processor that is programmed to perform the motion compensation and recursive temporal filtering algorithm.

For 1080I, each field motion vector (16×8) from first pass encoding applies to a 48×16 block of pixels in a video field. The top and bottom six lines in a 1080I frame are not filtered. For 720P, each frame motion vector (16×16) from first pass encoding applies to a 40×32 block of pixels in a video frame. The top and bottom four lines in a 720P frame are not filtered.

The filtered HDTV video is then delayed by a buffer 14 for, about fifteen frames for 1080I and thirty frames for 720P, so that the statistics for every frame are generated about half a second before the frame is actually encoded by the second pass encoder 15. This allows, the rate control and statmux algorithm, and the I-frame decision to be calculated with the advantage of looking ahead, as set forth in U.S. Patent Application Publication Nos.: US 2003/0235247-A1 “Methods and Apparatus for Rate Control During Dual Pass Encoding”; and US 2003/0235220-A1 “Methods and Apparatus for Statistical Multiplexing During Dual Pass Encoding” which have been previously incorporated by reference as if repeated herein in their entirety, including the drawings.

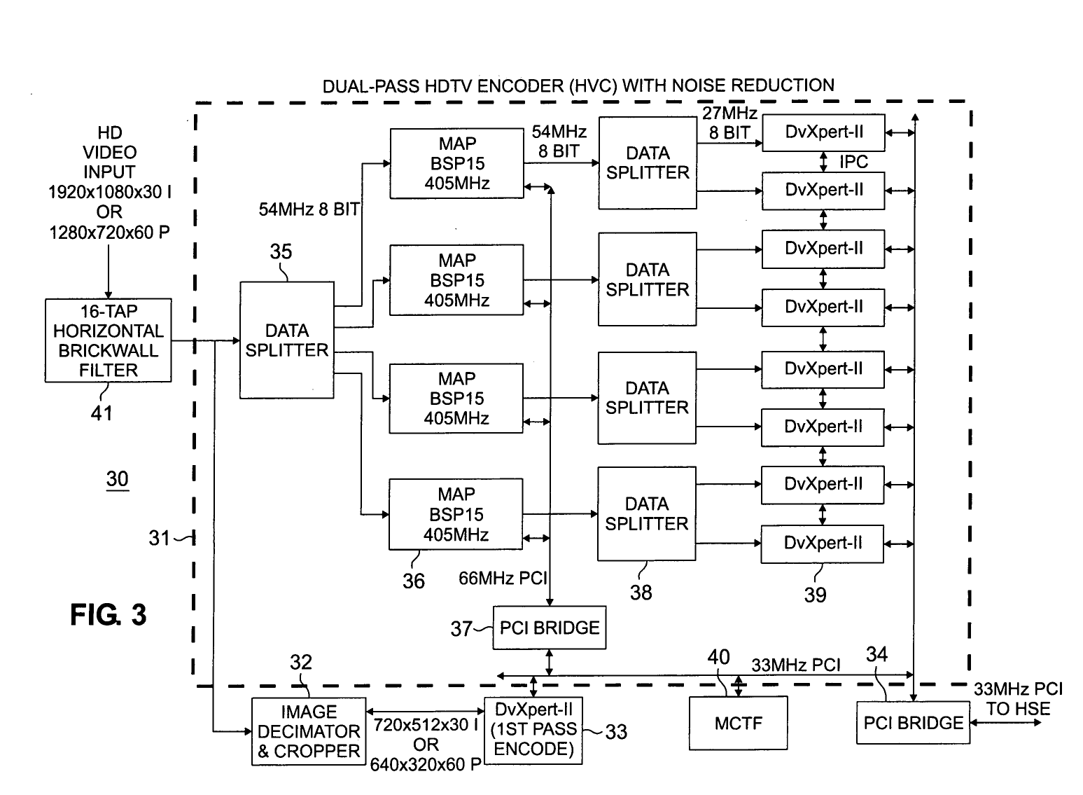

An example of a suitable second pass encoder 31 is shown in FIG. 3, which includes multiple encoders 39 (e.g., eight) similar to that used in the first pass encoding but coupled in parallel and performing encoding on a portion of the image in each frame. FIG. 3 shows the entire dual pass encoder 30, which includes a 16-tap horizontal brickwall filter 41, image decimator and cropper 32, first pass encoder 33, motion compensated temporal filter 40, PCI bridge 34 and second pass encoder 31. The second pass encoder 31 includes multiple splitters 35, 38, multiple digital signal processors 36, and multiple video panel encoders 39, as well as PCI bridge 37 to provide communications between the first pass encoding and the second pass encoding. In general, the second pass encoder employs multiple filters and data splitters to create eight separate signals that are then processed by panel encoders.

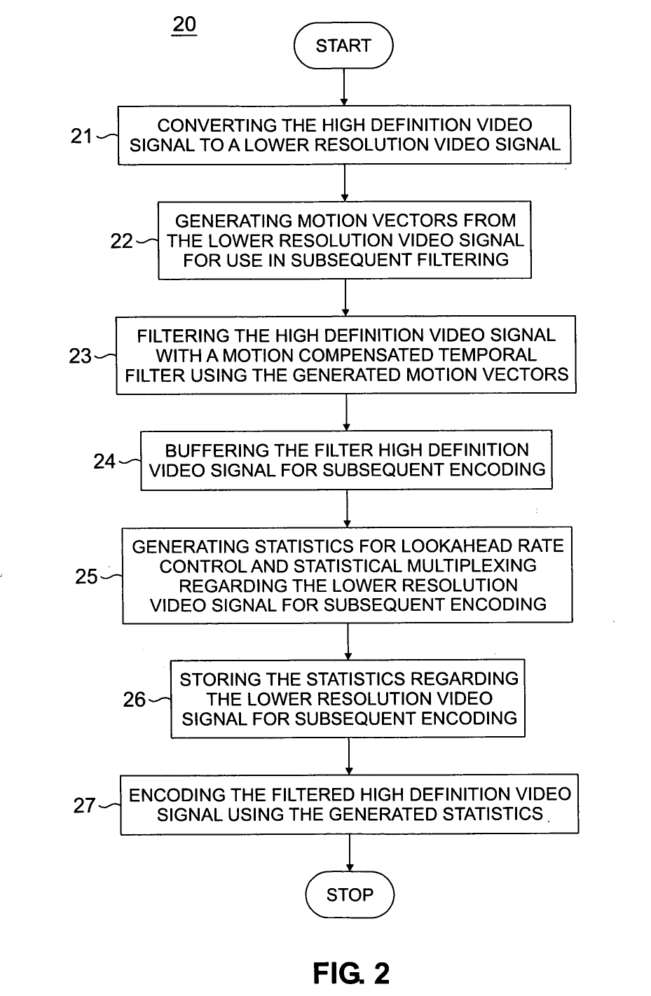

Turning to FIG. 2, shown therein is an exemplary embodiment 20 of a method for encoding a high definition video signal according to another aspect of the present invention. The present invention employs a dual pass encoding of the high definition video signal to enable rapid, but high quality encoding and compression.

In element 21, the high definition video signal is converted to a lower resolution video signal. This is accomplished by decimating and cropping the image in each frame as set forth above. An example of a lower resolution signal could be a standard video signal.

In element 22, motion vectors for the motion compensated temporal filter are generated as described above.

In element 23, the high definition video signal is then filtered using motion compensated temporal filtering that employs the motion vectors generated from the encoding of the lower resolution video signal.

In element 24, the filtered high definition video signal is delayed or buffered so that the statistics being generated can be employed by the second video encoder.

In element 25, statistics for look ahead rate control and statistical multiplexing are generated from the lower resolution video signal for subsequent use in the second pass encoding.

In element 26, the statistics are stored so they can be accessed by the encoder at the proper moment.

In element 27, a second pass encoder performs the high definition encoding of the filtered high definition signal using the previously generated statistics.

Although various embodiments are specifically illustrated and described herein, it will be appreciated that modifications and variations of the invention are covered by the above teachings and are within the purview of the appended claims without departing from the spirit and intended scope of the invention. For example, certain high definition signal formats and standard video formats are used in the examples herein, but the invention is not so limited to any particular format. Furthermore, these examples should not be interpreted to limit the modifications and variations of the invention covered by the claims but are merely illustrative of possible variations.

What is claimed is:

1. An apparatus (10) for encoding a high definition television signal comprising:
an image decimator and cropper (11) to convert the high definition television signal to a standard television signal;
a first video encoder (12) coupled to the image decimator and cropper (11) to generate motion vectors and statistics for look ahead rate control and statistical multiplexing related to the converted high definition television signal; and
a second video encoder (15) to receive the generated statistics, to receive the a filtered version of the high definition video signal and to encode the high definition video signal using the generated statistics.

2. The apparatus (10) according to claim 1, further comprising:
a buffer (14) to receive the filtered high definition television signal and to store the filtered high definition television signal for subsequent use.

3. The apparatus (10) according to claim 1, further comprising:
a buffer (16) coupled to the first encoder (12) to receive the generated statistics and to store the generated statistics for subsequent use.

4. The apparatus (10) according to claim 1, further comprising:
a filter (13) coupled to the first encoder (12) to receive the high definition television signal, to receive the generated motion vectors and to perform motion compensated temporal filtering of the received high definition television signal using the received generated motion vectors.

5. A method (20) for encoding a high definition video signal comprising:
converting (21) the high definition video signal to a lower resolution video signal;
generating (22) a plurality of motion vectors from the lower resolution video signal;
mapping the motion vectors of every pixel of the lower resolution video to multiple pixels in the high definition video signal.
filtering (23) the high definition video signal with a motion compensated temporal filter using the generated motion vectors;
generating (25) a plurality of statistics for look ahead rate control and statistical multiplexing regarding the standard video signal; and
encoding (27) the filtered high definition video signal using the generated statistics.

6. The method (20) according to claim 5, further comprising:
buffering (24) the filtered high definition television signal for subsequent encoding.

7. The apparatus (20) according to claim 1, further comprising:
storing (26) the generated statistics for subsequent encoding.

8. A method (20) for encoding a high definition video signal comprising:
generating (25) a plurality of statistics for lookahead rate control and statistical multiplexing regarding a lower resolution video version of the high definition video signal; and
encoding (27) the high definition video signal using the generated statistics.

9. The method (20) according to claim 8, further comprising:
generating (22) a plurality of motion vectors from a standard video version of the high definition video signal.

10. The method (20) according to claim 9, further comprising:
filtering (23) the high definition video signal using a motion compensated filter employing the generated plurality of motion vectors; and

11. The method (20) according to claim 10, further comprising:
storing (24) a filtered high definition television signal for subsequent encoding.

12. The method (20) according to claim 8, further comprising:
storing (26) the generated statistics for subsequent encoding.

13. A method (20) for encoding a high definition video signal comprising:
generating (22) a plurality of motion vectors from a lower resolution video version of the high definition video signal; and
filtering (23) the high definition video signal using a motion compensated filter employing the generated plurality of motion vectors; and
encoding (27) the filtered high definition video signal.

14. The method (20) according to claim 13, further comprising:
generating (25) a plurality of statistics for lookahead rate control and statistical multiplexing regarding a standard video version of the high definition video signal.

15. The method (20) according to claim 13, further comprising:
storing (24) a filtered high definition television signal for subsequent encoding.

16. The method (20) according to claim 14, further comprising:
storing (26) the generated statistics for subsequent encoding.

17. The method (20) according to claim 14, further comprising:
encoding (27) the high definition video signal using the generated statistics.

18. An apparatus (30) for encoding a high definition television signal comprising:
a first processor (32) to convert the high definition television signal to a lower resolution television signal;
a second processor (33) to generate statistics for look ahead rate control and statistical multiplexing related to the converted high definition television signal; and
a video encoder (31) to receive the generated statistics, to receive the high definition video signal and to encode the high definition video signal using the generated statistics.

19. The apparatus (30) according to claim 18, wherein the second processor (33) generates a plurality of motion vectors from the lower resolution television signal.

20. The apparatus (30) according to claim 19, further comprising:
a filter (40) coupled to the second processor (33) to receive the high definition television signal, to receive the generated motion vectors and to perform motion compensated temporal filtering of the received high definition television signal using the received generated motion vectors, wherein said video encoder (31) uses the filtered version of the high definition video signal for encoding.

21. The apparatus (30) according to claim 18, wherein said video encoder (31) includes a plurality of standard video encoders coupled in parallel each performing encoding of portions of the high definition signal.
